(19) United States
(12) Patent Application Publication
(10) Pub. No.: US 2011/0203194 A1
(43) Pub. Date: Aug. 25, 2011

(54) Actuatable Window Well Covering System

(76) Inventors: Daniel Kelsch, Herriman, UT (US); Jonah Kunz, Herriman, UT (US); Dale Kelsch, Herriman, UT (US)

(21) Appl. No.: 12/711,426

(22) Filed: Feb. 24, 2010

(51) Int. Cl. E06B 3/30; E06B 5/02; B23P 11/00

(52) U.S. Cl. 52/69; 52/173.1; 29/428

(57) ABSTRACT

A window well cover assembly comprises a cover grate, pivotally coupleable to a window well structure or a dwelling. At least one actuator is operable to pivot the cover grate from a closed position in which the cover grate is closed over the window well into an open position in which the cover grate is opened over the window well. A latching assembly is operable to maintain the cover grate in the closed position until released to allow the actuator to pivot the cover grate into the open position.

### FIELD OF THE INVENTION

1. Background

The present invention relates generally to devices suitable for covering window wells found in many homes and buildings.

2. Related Art

It is often the case that windows are installed in homes or other buildings below (or partially below) ground level. In such cases, a “well,” or open portion in the ground, adjacent the window is formed to allow light to enter the window and to allow human egress from the window. In many cases, these windows wells can present a hazardous situation to those near the windows outside of the home or building, as one might easily fall into the window well and become injured. This risk is particularly high when small children are playing near window wells.

Due to this situation, many homeowners choose to install covers over the window wells that prevent individuals from falling into the well. Such covers can also serve as security devices, preventing intruders from entering the home or building. A wide variety of different types of such covers have been designed, from relatively simple, transparent polymeric covers to ornate metal grates.

While such covers address the hazard of falling into the window well, they can serve to limit or hinder egress from the window by those inside of the home. This can be very problematic in the case of a fire or other emergency. In particular, heavy, ornate metal grate covers can be sufficiently heavy, or rusted or otherwise partially held in place, that small children, or even adults, find them difficult or impossible to remove from inside the window well.

### SUMMARY OF THE INVENTION

In accordance with one aspect, the present invention provides a window well cover assembly including a cover grate, pivotally coupleable to a window well structure or a dwelling. At least one actuator can be operable to pivot the cover grate from a closed position in which the cover grate is closed over the window well into an open position in which the cover grate is opened over the window well. A latching assembly can be operable to maintain the cover grate in the closed position until released to allow the actuator to pivot the cover grate into the open position.

In accordance with another aspect of the invention, a window well cover assembly is provided, including a cover grate, pivotally coupleable to a window well structure or a dwelling. At least one actuator can be operable to pivot the cover grate from a closed position in which the cover grate is closed over the window well into an open position in which the cover grate is opened over the window well. An actuator initiating system can be operable to initiate the actuator to cause the actuator to pivot the cover grate from the close position to the open position.

In accordance with another aspect of the invention, a method for installing a window well cover over a window well adjacent a dwelling is provided, including: pivotally coupling a cover grate to the window well or a dwelling adjacent the window well, the cover grate being operably coupled to at least one actuator operable to pivot the cover grate from a closed position in which the cover grate is closed over the window well into an open position in which the cover grate is opened over the window well; and latching the cover grate into the closed position with a latching assembly, the latching assembly operable to maintain the cover grate in the closed position until released to allow the actuator to pivot the cover grate into the open position.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a perspective view of a window well cover assembly in accordance with an embodiment of the invention, shown in an open position;

FIG. 1B is a perspective view of the window well cover assembly of FIG. 1A, shown in a closed position;

FIG. 2 is another perspective view of the window well cover of FIG. 1;

FIG. 3 is another perspective view of the window well cover of FIG. 1, including a protective grate installed therein; and

FIG. 4 is a perspective view of a window well cover having an adjustable support frame associated therewith.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to an “actuator” includes one or more of such actuators.

### DEFINITIONS

In describing and claiming the present invention, the following terminology will be used in accordance with the definitions set forth below.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

As used herein, the term “substantially” refers to the complete or nearly complete extent or degree of an action, characteristic, property, state, structure, item, or result. For example, when an object or group of objects is/are referred to as being “substantially” symmetrical, it is to be understood that the object or objects are either completely symmetrical or are nearly completely symmetrical. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. For example, an opening that is “substantially free of” material would either completely lack material, or so nearly completely lack material that the effect would be the same as if it completely lacked material. In other words, an opening that is “substantially free of” material may still actually contain some such material as long as there is no measurable effect as a result thereof.

### INVENTION

As illustrated generally in the figures, the present invention provides a window well cover assembly that can be used to provide a manner of safe and easy egress from a dwelling through a window well. The window well covers of the present invention can be used by very small, or not physically strong individuals, to move a cover grate from a window well, even in the case that the cover grate is very heavy, or is partially held in position by rust, debris, etc.

Generally speaking, dwellings that include windows installed below ground level typically include open spaces, or “wells,” adjacent the window that serve to allow light to enter the window. These wells also serve as a manner of human egress from the dwelling, should egress be necessary, through the window. In the following description, while reference will be made to various window wells, dwellings adjacent window wells, window structures, etc., these structures are not shown in detail in the figures: it being understood that one of ordinary skill in the art, having possession of this disclosure, would readily understand how the present invention can be incorporated into such known structures.

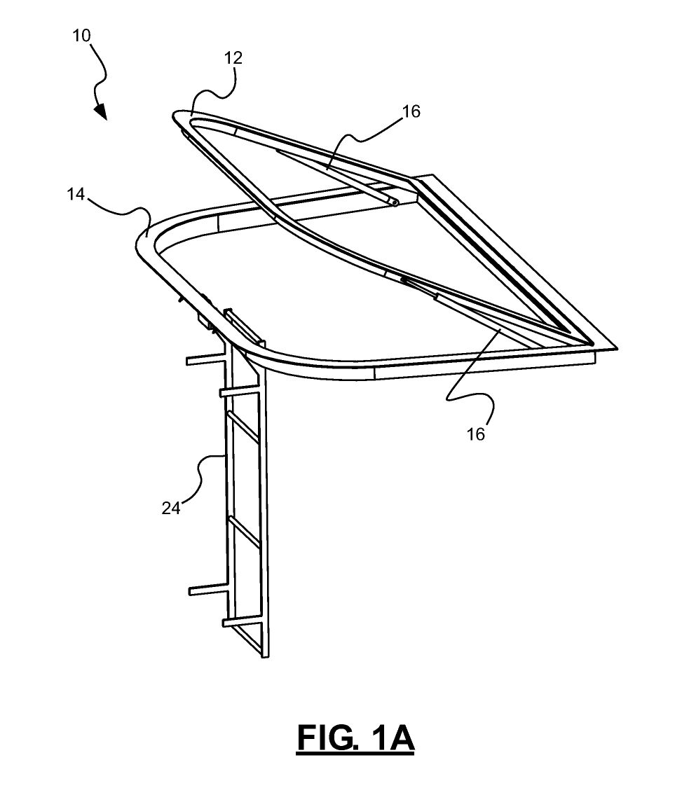

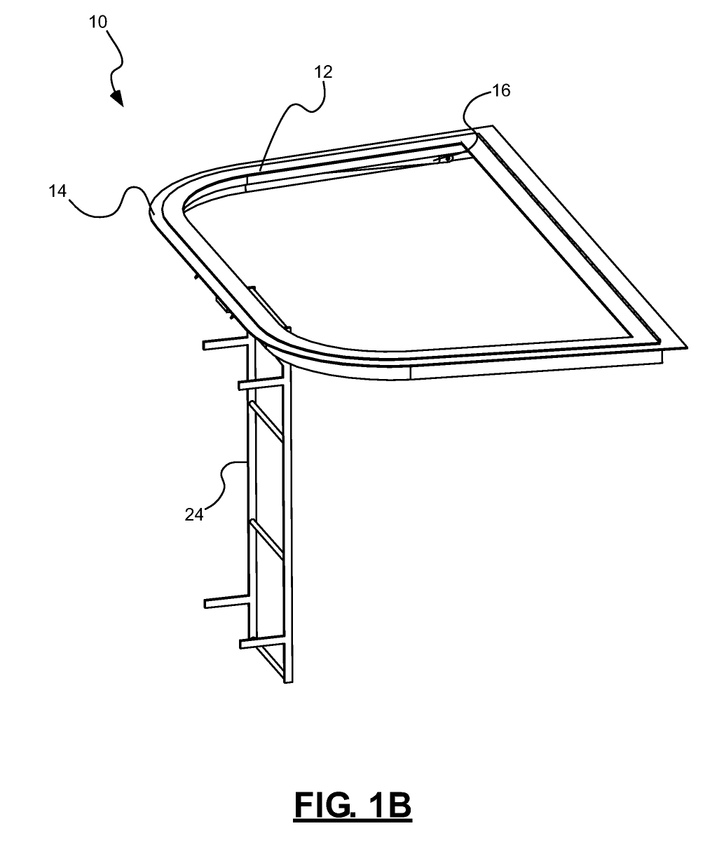

In one aspect of the invention, a window well cover assembly 10 of the present invention can include a cover grate 12 pivotally coupleable to a window well structure or a dwelling. In the example shown in FIGS. 1A and 1B, the window well cover assembly includes a skirt 14 that can be installed over (and/or partially within) a window well lining or other structure typically found associated with a window well. As the skirt is secured to the window well lining or window well, the cover grate 12 is free to pivot into the position shown in FIG. 1A (referenced herein as an “open position”) from a position in which the cover grate is settled into contact on or over the skirt (referenced herein as a “closed position”—shown in FIG. 1B).

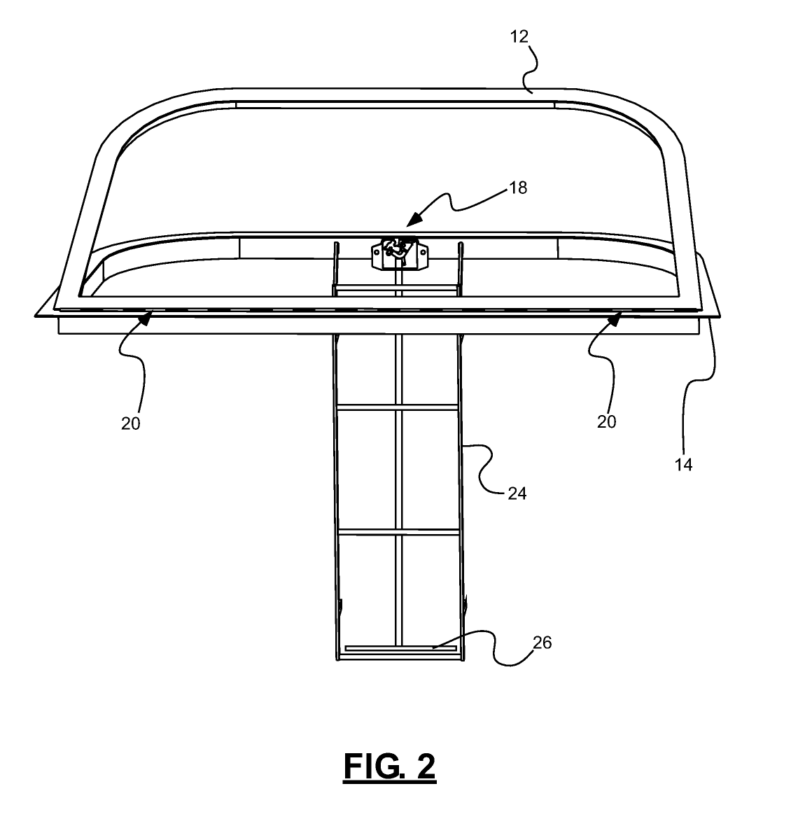

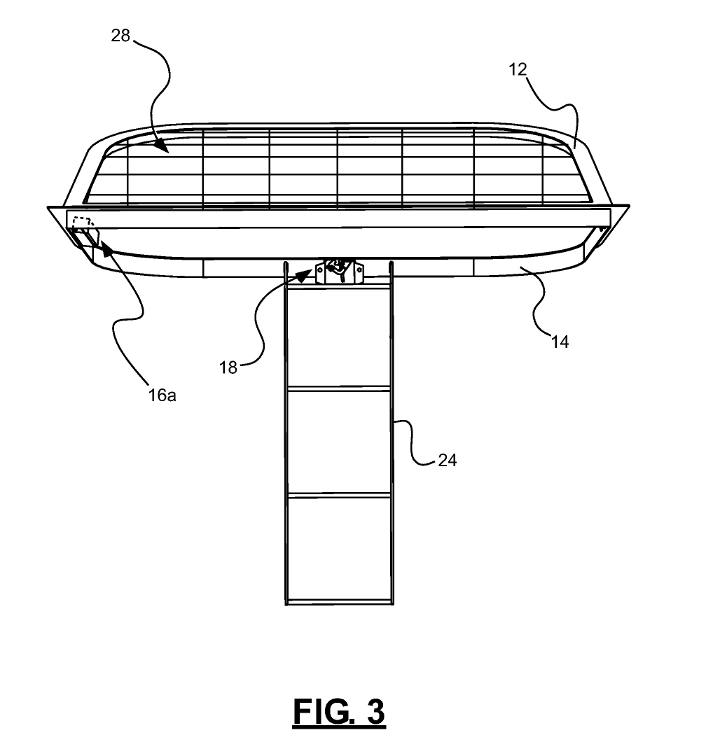

The system can include at least one actuator 16 that can be operable to pivot the cover grate 12 from a closed position in which the cover grate is closed over the window well into an open position in which the cover grate is opened over the window well. A latching assembly, shown generally at 18 in FIGS. 2 and 3, can be associated with the system and can be coupled, for example, to the skirt 14. The latching assembly can be operable to maintain the cover grate in the closed position until released to allow the actuator to pivot the cover grate into the open position.

Thus, the cover grate 12 is normally held in the closed position by the latching assembly 18. When it is desired to move the cover grate into the open position, a user can activate or initiate the latching assembly to thereby release the cover grate. The actuator or actuators 16 then force the cover grate from the closed position to the open position. As the force required on the user's part to activate or initiate the latching mechanism can be very small, even a small child can be taught to open the cover grate by him- or herself. Thus, if it becomes necessary for the child to exit a dwelling through the window well, he or she can do so with very little effort.

The actuator 16 can take a variety of forms. In one aspect, the actuator is biased in a compressive state when the cover grate is in the closed position. In this manner, the at least one actuator will cause the cover grate to pivot or rotate into the open position as soon as the latching assembly releases the cover grate. Examples of suitable actuators include, without limitation, gas springs, coiled springs, torsional springs, beam springs, and the like. As best shown in FIG. 2, the system can include at least one hinge 20. While the figures illustrate a system in which the actuator and the hinge are separate components, in one aspect, the hinge and actuator can be integrated into a single unit. For example, a spring-hinge combination can be installed instead of the hinge 20, in which case the actuators 16 shown need not be installed.

In addition to actuators that utilize mechanically stored energy (e.g., springs and the like), the system can also include actuators that utilize an auxiliary power source that is initiated by the latching mechanism 18. For example, a generic actuator 16a can be coupled to the cover grate 12, as shown in FIG. 3. The actuator 16a can be powered by electricity supplied from the dwelling, a battery or solar source, etc. A control system (not shown) can be incorporated into the system to initiate or activate the actuator 16a when desired. In one example, to open the cover grate, an operator need only initiate the latching mechanism (or some system intermediate the latching system and the actuator), and the actuator will be energized and will lift the cover grate into the open position. Examples of suitable actuators for use in this embodiment include linear electric actuators, electric rotational motors, and the like.

The system can also include a ladder 24 that can aid the user in climbing upwardly and out of the window well. In one aspect, shown by example in FIG. 2, the system can include a release mechanism 26 (part of an overall actuator initiation system) that can extend distally from the latching mechanism so as to be actuatable from a distance from the cover grate 12. In this manner, not only is it easier for a user who just exited a window (e.g., who has climbed onto or into the bottom of the window well) to actuate the latching mechanism, but it is more difficult for someone outside of the dwelling to actuate the latching mechanism. Thus, the system is better able to prevent intruders from entering the dwelling. In one aspect, the latching mechanism can be initiated only via a remote initiation system.

In the system shown in FIG. 2, the latching mechanism can include a downwardly extending lower bar that is actuated when a user places his or her foot upon one of the rungs of the ladder 24. Thus, even very small children, or people unfamiliar with how the system operates, can open the cover grate as a natural consequence of using the ladder to exit the window well. The downwardly extending bar serves to allow initiation of the actuating system remotely from the latching assembly 18. This can also be accomplished by way of a cabling system, pull cord, etc., as would occur to one of ordinary skill in the art having possession of this disclosure.

As shown in FIG. 3, the cover grate 12 can include cover structure 28 that can serve to restrict or limit people or objects from falling into the window well. In the example shown, the cover structure includes a series of spaced-apart bars or links that form a grate. Variations on this structure can include expanded metal materials, solid sheets of translucent or transparent polymers, etc.

While the exemplary system illustrated in the figures includes a skirt 14 to which some or all of the components of the cover grate 12 can be coupled, in one embodiment of the invention, no skirt or other intermediate structure is included. In this aspect, the cover grate 12, actuator 16, latching assembly 18, etc., can all be coupled or otherwise associated with structure generally found adjacent typical window wells. For example, many such window wells include a corrugated steel lining: the various components of the present system can be coupled or attached to the lining instead of using a skirt.

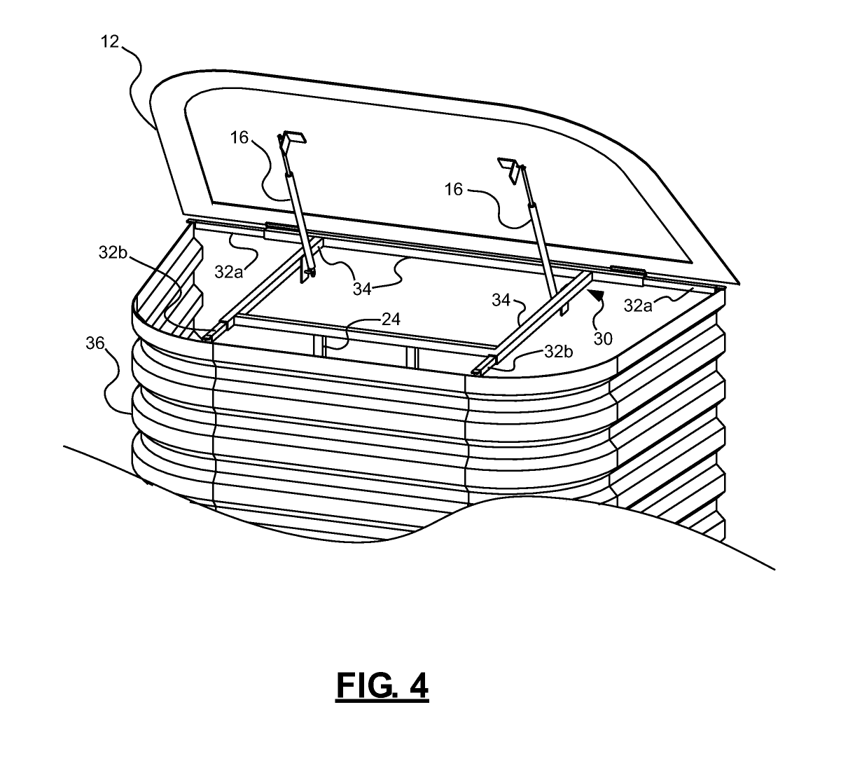

A further exemplary aspect of the invention is illustrated in FIG. 4. In this embodiment, an adjustable support frame 30 is provided that can facilitate installation of the window well cover into window wells of varying size. The adjustable support frame can include one or more extendable members 32a, 32b that can be extended from one or more stationary members 34 and can be coupled to or securely engage structure adjacent or within the window well. For example, the extendable members 32a, 32b can extend outwardly from stationary members 34 and can be coupled to, or can securely engage, or can rest upon steel window well lining 36.

The extendable members 32a, 32b can move relative to the stationary members 34 in a variety of manners. In the example shown in FIG. 4, the stationary members are tubular, and the extendable members can slide inwardly and outwardly within the stationary members. Various manners (not shown) of temporarily securing the extendable members to the stationary members (once the frame has been adjusted to fit the window well properly) can be employed. Such manners of securing can include, without limitation, set-screw arrangements, pins, welding, through-hole bolts, etc. In addition, it is contemplated that the extendable members can be threadably engaged within the stationary members and can be threadably extended and retracted relative to the stationary members to achieve proper adjustment.

Thus, it is contemplated that, once the frame has been adjusted properly to fit within a particular window well, the extendable member 32a, 32b can be secured relative to the stationary members 34 to provide a rigid framework for supporting the weight of the cover grate 12 as it is being moved into, or held in, the open position. The extendable and stationary members can be arranged so as to create an open space for a person to exit the window well via ladder 24.

As is shown, one or more actuators 16 can be coupled to the adjustable frame member to allow operation of the cover grate as discussed in the embodiments above. It is also contemplated, however, that the actuators can be coupled to structure adjacent to or within the window well (e.g., the steel lining 36) if such an arrangement is desirable.

In addition to the structural components discussed above, in one aspect of the invention a method for installing a window well cover over a window well adjacent a dwelling is provided, including: pivotally coupling a cover grate to the window well or a dwelling adjacent the window well, the cover grate being operably coupled to at least one actuator operable to pivot the cover grate from a closed position in which the cover grate is closed over the window well into an open position in which the cover grate is opened over the window well; and latching the cover grate into the closed position with a latching assembly, the latching assembly operable to maintain the cover grate in the closed position until released to allow the actuator to pivot the cover grate into the open position.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

I claim:

1. A window well cover assembly, comprising:
a cover grate, pivotally coupleable to a window well structure or a dwelling;
at least one actuator, operable to pivot the cover grate from a closed position in which the cover grate is closed over the window well into an open position in which the cover grate is opened over the window well; and
a latching assembly, the latching assembly operable to maintain the cover grate in the closed position until released to allow the actuator to pivot the cover grate into the open position.

2. The assembly of claim 1, wherein the at least one actuator is biased in a compressive state when the cover grate is in the closed position, such that the at least one actuator pivots the cover grate into the open position when the latching assembly releases the cover grate.

3. The assembly of claim 2, wherein the actuator comprises a gas spring.

4. The assembly of claim 1, wherein the actuator is powered by an auxiliary energy source.

5. The assembly of claim 1, further comprising a ladder, associated with the window well cover assembly or the window well, the ladder facilitating egress from a dwelling through the window well cover.

6. The assembly of claim 5, wherein the ladder is operably coupled to the latching mechanism, and wherein the latching mechanism releases the cover grate upon application of weight to or adjacent a portion of the ladder.

7. The assembly of claim 1, wherein the latching mechanism includes a release mechanism disposed or extending below the cover grate so as to be substantially inaccessible from outside the window well.

8. The assembly of claim 1, further comprising an adjustable support frame that can be adjusted in size to fit varying-sized window wells, and wherein the at least one cover grate is operably coupled to the adjustable support frame.

9. The assembly of claim 8, wherein the adjustable support frame is adjustable in at least two substantially horizontal directions.

10. A window well cover assembly, comprising:
a cover grate, pivotally coupleable to a window well structure or a dwelling;
at least one actuator, operable to pivot the cover grate from a closed position in which the cover grate is closed over the window well into an open position in which the cover grate is opened over the window well; and
an actuator initiating system, operable to initiate the actuator to cause the actuator to pivot the cover grate from the close position to the open position.

11. The assembly of claim 10, wherein the actuator comprises a biased element held in a compressed condition when the cover grate is in the closed position.

12. The assembly of claim 11, wherein the actuator initiating system comprises a latching mechanism that maintains the cover grate in the closed position until initiated to release the cover grate.

13. The assembly of claim 10, further comprising a ladder, associated with the window well cover assembly or the window well, the ladder facilitating egress from a dwelling through the window well cover, and wherein the ladder is operably coupled to the actuator initiating system such that application of weight to or adjacent a portion of the ladder results in the actuator releasing the cover grate into the open position.

14. A method for installing a window well cover over a window well adjacent a dwelling, comprising:
pivotally coupling a cover grate to the window well or a dwelling adjacent the window well, the cover grate being operably coupled to at least one actuator operable to pivot the cover grate from a closed position in which the cover grate is closed over the window well into an open position in which the cover grate is opened over the window well; and
latching the cover grate into the closed position with a latching assembly, the latching assembly operable to maintain the cover grate in the closed position until released to allow the actuator to pivot the cover grate into the open position.

15. The method of claim 14, further comprising associating a release mechanism with the latching assembly and disposing or extending the release mechanism below the cover grate so as to be substantially inaccessible from outside the window well.

16. The method of claim 14, wherein the at least one actuator is biased in a compressive state when the cover grate is in the closed position, such that the at least one actuator pivots the cover grate into the open position when the latching assembly releases the cover grate.

17. The method of claim 14, wherein the actuator comprises a gas spring.

18. The method of claim 14, further comprising installing a ladder adjacent to or within the window well and associating the ladder with the window well cover assembly or the window well, the ladder facilitating egress from the dwelling through the window well cover.

19. The method of claim 18, wherein the ladder is operably coupled to the latching mechanism, and wherein the latching mechanism releases the cover grate upon application of weight to or adjacent a portion of the ladder.

20. The window well cover assembly of claim 1, further comprising a skirt, installable within or attachable to the window well structure, and wherein at least one of the cover grate, actuator and latching assembly are coupled to the skirt.
